(19) United States
(12) Patent Application Publication
(10) Pub. No.: US 2025/0004674 A1
(43) Pub. Date: Jan. 2, 2025

(54) STORAGE MEDIUM, INFORMATION PROCESSING METHOD, AND INFORMATION PROCESSING DEVICE

(71) Applicant: CANON KABUSHIKI KAISHA, Tokyo (JP)

(72) Inventor: TSUBASA OCHIAI, Chiba (JP)

(21) Appl. No.: 18/753,959

(22) Filed: Jun. 25, 2024

(30) Foreign Application Priority Data
Jun. 29, 2023 (JP) 2023-106708

(51) Int. Cl. G06F 3/12

(52) U.S. Cl. CPC G06F 3/1208; G06F 3/1253

(57) ABSTRACT

A program for extending the functionality of general-purpose printing software commonly usable by image forming devices provided by multiple manufacturers allows a user to use a sharpness function. An information processing method for extending functionality of general-purpose printing software commonly usable by image forming devices provided by multiple manufacturers, includes: displaying, on a display unit, a display screen that accepts a setting for sharpness processing; and based on the setting accepted on the display screen, for image data generated by the general-purpose printing software, setting that the sharpness processing be executed by an image forming device to which the image data is sent.

### BACKGROUND

### Field of the Disclosure

The present disclosure relates to a storage medium, an information processing method, and an information processing device.

### Description of the Related Art

A configuration is known in which a printer driver installed on a host computer as control software for a printing device is used to issue a print instruction to a printing device connected to the host computer. The host computer has an operating system (OS), which is the basic software, installed, and the printer driver is configured according to the specifications defined by the OS and is called and operated by the OS. Vendors (manufacturers) offering printing devices provide a printer driver that conforms to the specifications of the OS, thereby providing a means to instruct, using the OS, their printing devices to print.

In recent years, Windows® has provided a standard class driver (hereinafter also referred to as a “standard driver”) that is commonly usable by printing devices offered by multiple vendors. Such a standard driver is included within the OS package, allowing it to be usable simply by connecting any printing device to the host computer. Therefore, it is not necessary to separately install a model-specific printer driver suitable for the printing device, which enhances convenience. Additionally, the standard driver is configured to be able to specify print functions in accordance with Print Device Capabilities (hereinafter referred to as “PDC”) generated based on information obtained from the connected printing device. This allows a user using the standard driver to specify print functions tailored to the capabilities of the connected printing device, even though the user is using one standard driver. However, this is limited to the functions that can be realized by the standard driver alone, and it is not possible to specify functions unique to each printer vendor.

Accordingly, Japanese Patent Laid-Open No. 2021-33526 discloses techniques for extending the functionality by using an extension application of a standard driver, enabling color printing, poster printing, and bookbinding printing, which are functions unique to each printer vendor.

Here, a sharpness function is one of the functions unique to each printer vendor's printer driver. The sharpness function is a function that allows the adjustment of the sharpness of print data. The sharpness function enhances sharpness by emphasizing the edges, such as in photographs. The sharpness function can alternatively reduce sharpness by performing smoothing processing. The user can choose to print an image by either enhancing its sharpness, reducing its sharpness, or not using the sharpness function at all.

However, in the case of using the standard driver, the sharpness function is not available. In Japanese Patent Laid-Open No. 2021-33526, with the use of the extension application of the standard driver, color printing, poster printing, and bookbinding printing can be realized in printing using the standard driver, but this does not enable the use of the sharpness function.

### SUMMARY

Embodiments of the present disclosure provide a non-transitory computer-readable storage medium storing a program that extends functionality of general-purpose printing software commonly usable by image forming devices provided by multiple manufacturers, the program, which when executed by one or more processors of a computer, cause the computer to perform operations including: displaying, on a display unit, a display screen that accepts a setting for sharpness processing; and, based on the setting accepted on the display screen, for image data generated by the general-purpose printing software, setting that the sharpness processing be executed by an image forming device to which the image data is sent.

Further features of the present disclosure will become apparent from the following description of exemplary embodiments with reference to the attached drawings.

### BRIEF DESCRIPTION OF THE DRAWINGS

FIG. 1 is a block diagram illustrating the hardware configuration of a printing system.

FIGS. 2A and 2B are software configuration diagrams of the printing system.

FIG. 3 is a diagram illustrating the processing flow of sharpness processing performed by a printing device.

FIGS. 4A, 4B, 4C, and 4D are image diagrams after the sharpness processing.

FIGS. 5A, 5B, and 5C are diagrams each illustrating an example of a print settings screen displayed by a print settings screen extension unit.

FIG. 6 is a diagram illustrating the processing flow of PDC editing processing performed by a print function extension unit.

FIG. 7 is a diagram illustrating an example of capability information obtained from the printing device.

FIG. 8 is a diagram illustrating an example of a list of print functions supported by an extension application.

FIG. 9 is a diagram illustrating an example of a list of print functions supported by general-purpose printing software.

FIG. 10 is a sequence diagram of a rendering application, the general-purpose printing software, the extension application, and the printing device.

FIG. 11 is a diagram illustrating the configuration of a printing system according to a second embodiment in the case where an extension application is associated.

FIG. 12 is a diagram illustrating the processing flow of PDC editing processing performed by a print function extension unit in the second embodiment.

FIG. 13 is a diagram illustrating an example of capability information obtained from a printing device in the second embodiment.

FIG. 14 is a sequence diagram of the rendering application, the general-purpose printing software, the extension application, and the printing device in the second embodiment.

### DESCRIPTION OF THE EMBODIMENTS

Hereinafter, embodiments of the present disclosure will be described in detail with reference to the accompanying drawings. Note that the following embodiments are not construed to restrict the present disclosure, and not all of the combinations of features described in the embodiments are essential to the solution of the present disclosure.

Note that identical components will be given identical reference numerals and their description will be omitted.

### First Embodiment

### <Hardware Configuration of Printing System>

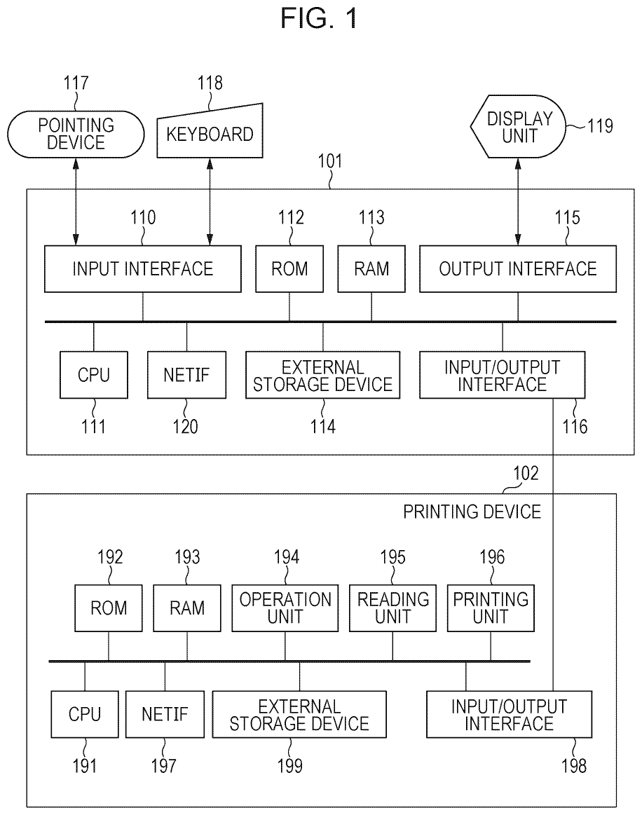

FIG. 1 is a block diagram illustrating the hardware configuration of a printing system. In FIG. 1, a host computer 101 is an example of an information processing device and has an input interface 110, a central processing unit (CPU) 111, a read-only memory (ROM) 112, a random-access memory (RAM) 113, an external storage device 114, an output interface 115, and an input/output interface 116. Also, input devices such as a keyboard 118 and a pointing device 117 are connected to the input interface 110, whereas a display device such as a display unit 119 is connected to the output interface 115. A network interface (NET IF) 120 performs control for performing data transfer to and from external devices over a network.

The ROM 112 stores an initialization program. The external storage device 114 is, for example, a hard disk drive (HDD) or a solid state drive (SSD). The external storage device 114 stores a set of application programs, an operating system (OS), print data generation software, and various other types of data. The RAM 113 is used as a work memory or the like during execution of various programs stored in the external storage device 114, and the various programs can run within the host computer 101.

Note that, in the present embodiment, the CPU 111 performs processing according to the code of a program stored in the ROM 112 to execute the later-described functions of the host computer 101 as well as the processing according to later-described flowcharts.

A printing device 102, which is a device, is an example of an image forming device and is connected to the host computer 101 via an input/output interface 198 of the printing device 102 and the input/output interface 116 of the host computer 101. The input/output interface 198 of the printing device 102 and the input/output interface 116 of the host computer 101 may be connected via a wired network or a wireless network.

The printing device 102 has a CPU 191, a ROM 192, a RAM 193, an operation unit 194, a reading unit 195, a printing unit 196, a network interface (NET IF) 197, the input/output interface 198, and an external storage device 199.

The CPU 191 comprehensively controls the printing device 102. The ROM 192 is a memory that stores programs. The RAM 193 is a memory that temporarily stores programs and image data. The reading unit 195 is a scanner that reads the image of a document. Note that the reading unit 195 is not essential. The printing unit 196 prints an image on a sheet based on image data.

The NET IF 197 performs control for performing data transfer to and from external devices over a network.

Here, the host computer 101 and the printing device 102 are configured separately, but they may be configured as a single information processing device. Additionally, a print settings screen and a detailed settings screen, which will be described later, are to be displayed on the display unit 119. Note that, in the present embodiment, an electrophotographic digital multifunction machine having multiple functions including copying, printing, and faxing will be described as an example of a printing device. However, this is not the only possible case, and the present embodiment is also applicable to devices using other processes such as an inkjet system. Furthermore, it is permissible to configure the host computer 101 as a desktop computer, a smartphone, or a laptop.

### <Configuration of Software-Centric Printing System>

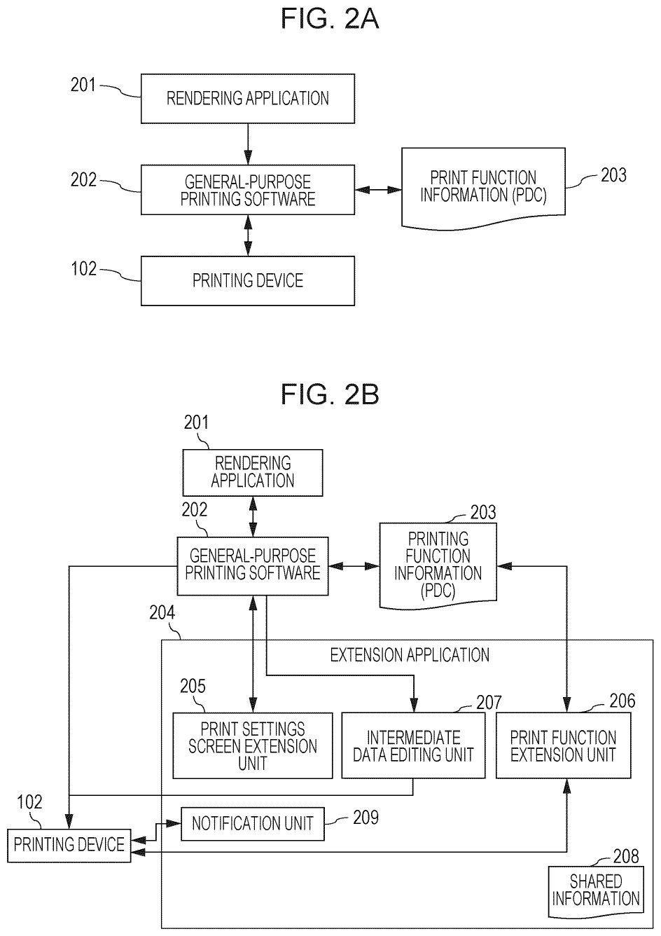

FIGS. 2A and 2B are diagrams schematically illustrating the software configuration of the printing system. The software configuration illustrated in FIGS. 2A and 2B is stored in the external storage device 114 illustrated in FIG. 1. Here, the printing system using the host computer 101 equipped with Microsoft® Windows® 11 as its OS will be described. FIG. 2A is a diagram illustrating a general configuration in the case where an extension application 204 is neither associated with general-purpose printing software 202 nor the printing device 102. FIG. 2B is a diagram illustrating the configuration in the case where the extension application 204 is associated with the general-purpose printing software 202 and the printing device 102.

<Configuration of Software-Centric Printing System (Case where Extension Application 204 is not Associated)>

First, using FIG. 2A, the configuration of the printing system in the case where the extension application 204 is not associated will be described.

A rendering application 201 is software that creates content to be printed (rendering data). For example, document creation applications and spreadsheet applications correspond to the rendering application 201. Upon receiving a print request from a user, the rendering application 201 issues a print instruction to the OS. The print instruction includes print settings information for directing the operation of the general-purpose printing software 202 and the printing device 102. The print settings information is also referred to as a Print Ticket (hereinafter abbreviated as “PT”).

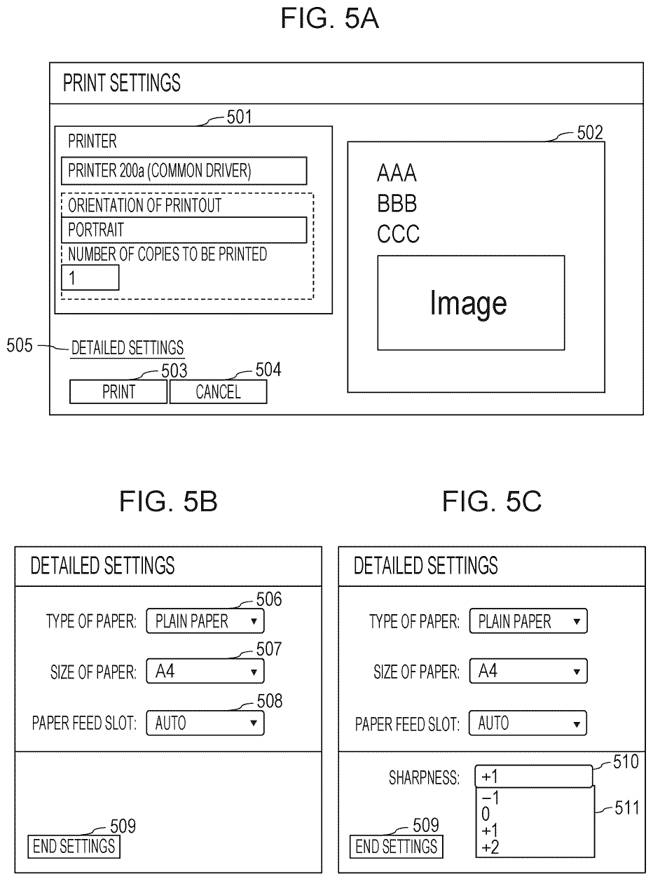

The rendering application 201 may display a print settings screen provided by any of the general-purpose printing software 202, the OS, or the rendering application 201 in order to output PT. In addition, when “detailed settings” within the print settings screen is pressed, the general-purpose printing software 202 additionally displays a detailed settings screen. The print settings screen and the detailed settings screen will be described later using FIGS. 5A to 5C. The detailed settings screen includes setting items (hereinafter referred to as “control items”) indicating print functions that can be set according to the capability information (configurable information) of the general-purpose printing software 202, and control items indicating their setting values. The capability information is also referred to as Print Capabilities (hereinafter abbreviated as “PC”). The general-purpose printing software 202 determines PC based on print function information 203. The print function information 203 is data indicating all the print functions that can be set and their setting values, as well as print functions in which exclusive relationships between the setting values are described. The print function information 203 is also referred to as Print Device Capabilities (PDC). The PDC 203 is included in the configuration file of the general-purpose printing software 202 and is placed in the external storage device 114 as an unchangeable file. Alternatively, the PDC 203 can be dynamically generated by the general-purpose printing software 202. Specifically, the general-purpose printing software 202 or the OS may be configured to obtain printing device attribute data from the printing device 102 and generate the PDC 203 in accordance with attribute information within the obtained attribute data. In the case where the PDC 203 is dynamically generated, the generated PDC 203 is editable. Note that the printing device attribute data obtained from the printing device 102 is a response obtained by issuing a Get-Printer-Attributes operation of the International Print Protocol (IPP) to the printing device 102. The response contains attribute information indicating functions (capabilities of the printing device 102) that can be specified in the printing device 102 and their setting values related to the attribute information. The response is stored in the RAM 113.

By configuring it this way, the general-purpose printing software 202 can be configured to allow the user to specify the print functions available in each printing device 102, depending on the connected printing device 102. That is, even if a printing device with different functions or a printing device developed by a different vendor is connected, the general-purpose printing software 202 can be configured to allow the user to specify the print functions available depending on the connected printing device. Note that the vendor may be the manufacturer of the printing device 102. Note that the description here will cover the configuration using the IPP Class Driver, which is included in Windows®11, as the general-purpose printing software 202. The IPP Class Driver is a printer driver that executes printing processing according to the specifications of a standard printing protocol called the Internet Print Protocol (IPP), and is included in the OS package. The IPP Class Driver is not a unique printer driver tailored to the model of the printing device 102, but rather a standard class driver that is commonly usable by multiple printing devices. Additionally, the IPP Class Driver obtains the capability information of the connected printing device 102 to allow the user to specify the print functions supported by the connected printing device 102, and, based on this information, generates the PDC 203. However, the IPP Class Driver does not support the sharpness function. This is because the sharpness function is a function unique to the printer vendor (printer manufacturer). Here, the following four points will be described: the sharpness function, use cases for the sharpness function, the sharpness processing flow, and the sharpness effects in the present embodiment. First, the sharpness function will be described.

### <Sharpness Function>

The sharpness function is a function that allows the adjustment of the sharpness of print data. The sharpness function enhances sharpness by emphasizing the edges in photographs. The sharpness function can alternatively reduce sharpness by performing smoothing processing. The user can choose to print an image by either enhancing its sharpness, reducing its sharpness, or not using the sharpness function at all. The processing flow of the sharpness processing will be described in detail later. Additionally, the sharpness function can also adjust the level of sharpness enhancement or reduction. Specifically, the printing device 102 can adjust the level of sharpness enhancement or reduction by holding multiple filter coefficients described in the later-described processing flow and switching the filter coefficients based on the sharpness setting configured by the user.

### <Use Cases for Sharpness Function>

Next, the use cases for the sharpness function will be described. In general, print samples tend to be less sharp compared to the results displayed on the screen. This is because when digital data is printed, the digital data cannot be faithfully reproduced due to analog factors of the printer. If the user feels that the print sample is blurred, the user configures the sharpness setting to enhance sharpness on the printer driver or the UI screen of the printer, and prints the digital data again.

This allows the user to adjust the image quality to the user's intended quality.

### <Sharpness Processing Flow>

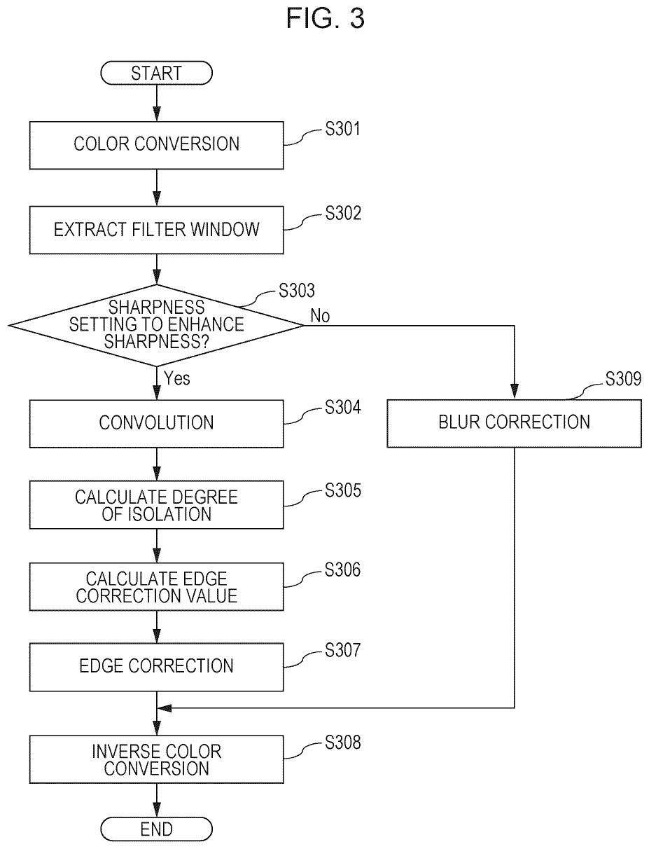

Next, the flow of the sharpness processing performed by the printing device 102 will be described using the flowchart of the sharpness processing illustrated in FIG. 3. Note that each step in FIG. 3 is realized by the CPU 191 of the printing device 102, which reads a program stored in the ROM 192 or the external storage device 199 into the RAM 193 and executes it.

First, in S301, the printing device 102 performs color conversion processing on the input image data to convert it into image data consisting of a luminance and chrominance color space. With this conversion, only the luminance component would undergo filter processing in subsequent steps, which means that only the brightness of the edges is processed, minimizing color conversion at the edges to some extent. In the present embodiment, the printing device 102 performs conversion from the RGB color space to the YCbCr color space. The color conversion formula is indicated below:

$$Y = 0.299 * R + 0.587 * G + 0.114 * B \qquad formula ( 1 )$$

$$Cb = - 0.1687 * - 0.3313 * G + 0.5 * B$$

$$Cr = 0.5 * R - 0.4187 * G - 0.0813 * B$$

Next, in S302, the printing device 102 extracts a window of a certain size consisting of multiple pixels from the YCbCr image data obtained in S301. In the present embodiment, the window has 5×5 pixels.

Then, in S303, the printing device 102 determines whether the sharpness setting has been configured to enhance sharpness. If it is determined to be YES, the process proceeds to step S304 and beyond, and if it is determined to be NO, the process proceeds to step S309. First, the case of proceeding to step S304 and beyond will be described.

Now in S304, the printing device 102 performs a filter processing operation on the luminance Y signal of the window obtained in S302 to perform edge enhancement processing. A general method for edge enhancement processing involves using a Laplacian filter to calculate the second derivative component, which is then added to the original image's signal values. The calculation of the second derivative component is performed using the following filter coefficients. Hereinafter, the following filter coefficients are referred to as the coefficients for sharpness “+1”:
−0.09, −0.18, −0.27, −0.18, −0.09
−0.18, +0.09, +0.36, +0.09, −0.18
−0.27, +0.36, +1.08, +0.36, −0.27
−0.18, +0.09, +0.36, +0.09, −0.18
−0.09, −0.18, −0.27, −0.18, −0.09

The center of this 5×5 matrix (in this example, the position multiplied by 1.08) becomes the pixel of interest for this window and is the output result of this position. The edge component of the luminance thus obtained is treated as dY thereafter. The value of this dY is the amount by which the luminance Y of the pixel of interest has changed due to the processing in S304; the absolute value of dY is larger in the edges, indicating larger amounts of changes in the original image. In addition, if the sign of dY is “+”, the pixel of interest is determined to be bright with respect to the surrounding pixels, and if the sign of dY is “−”, the pixel of interest is determined to be dark with respect to the surrounding pixels.

Next, in S305, the printing device 102 determines whether the pixel of interest of the window extracted by the processing in S302 is an isolated pixel from the surrounding pixels, and determines the degree of isolation within the window. A specific process involves calculating the average value aveY of the luminance (Y) component of eight pixels, excluding the pixel of interest, within the extracted window using equation (3) below, and calculating the standard deviation devY using equation (4) below:

$$aveY = 1 / 16 * \sum Y ( i ) \qquad equation ( 3 )$$

$$devY = 1 / 16 \sum ( aveY ( i ) ) \hat{} 2 \qquad equation ( 4 )$$

The smaller the standard deviation, the smaller the variation among the pixels, indicating that the surrounding area is a flat image. The correspondence relationship of the degree of isolation is as follows. Note that |dY| below indicates the absolute value of dY:
the case in which devY is small and |dY| is small means a low degree of isolation;
the case in which devY is small and |dY| is large means a high degree of isolation;
the case in which devY is large and |dY| is small means a low degree of isolation; and
the case in which devY is large and |dY| is large means a low degree of isolation.

For example, in the case where the standard deviation devY is large, it is estimated that the pixel of interest is not an isolated pixel because changes in the surroundings are large. Conversely, in the case where the standard deviation devY is small, there is a possibility that the pixel of interest is an isolated pixel. In the case where the standard deviation devY is small and the absolute value |dY| of the edge component dY is large, it can be estimated that the pixel of interest is an isolated pixel because, despite the large edge component, changes in the surrounding pixels are small and flat. Additionally, the case where the absolute value |dY| of the edge component dY is small and the standard deviation devY is also small indicates a flat image.

Next, in S306, the printing device 102 determines the degree of edge enhancement depending on dY obtained in S304 and the degree of isolation obtained in S305. Here, areas that are bright and isolated are considered to be specular reflection components, and therefore, enhancing the edges in these bright and isolated areas involves minimal image quality degradation. Conversely, enhancing the edges in areas that are dark and isolated may cause image quality degradation, so it is controlled to suppress edge enhancement in areas that are dark and isolated. That is, the printing device 102 applies control to suppress edge enhancement only in the case where the sign of dY is “−” and the degree of isolation is large. A specific process involves calculating a correction value α using a look up table (LUT) using the standard deviation devY in the case where the sign of dY is The correction value α is a value that approaches the maximum value 1.0 as the value of devY becomes larger, and approaches the minimum value 0.0 as the value of devY becomes smaller. The use of the correction value α will be described later in S307.

Next, in S307, the printing device 102 obtains the final luminance Y′ using equation (5) below based on α obtained in S306, dY obtained in S304, and the luminance Y obtained in S301:

$${Y}^{′} = Y + α * dY \qquad equation ( 5 )$$

Since the maximum value of a is 1.0, the maximum edge enhancement is performed at 1.0. As a decreases below 1.0, the second derivative component dY which is the added amount, calculated through convolution, decreases, and the amount of change in the original image becomes smaller, leading to suppression of edge enhancement. Note that, if Y′ exceeds the maximum value or the minimum value, Y′ may be clipped to the maximum value or the minimum value.

Then, in S308, the printing device 102 converts the output to RGB. This calculation corresponds to the inverse matrix of the color conversion performed in S301 and is converted according to formula (6) below:

$$R = {Y}^{′} + 1.402 * Cr \qquad formula ( 6 )$$

$$G = {Y}^{′} - 0.3441 * Cb - 0.7141 * Cr$$

$$B = {Y}^{′} + 1.772 * Cb$$

Finally, the case of proceeding from S303 to S309 will be described. If the sharpness setting has been configured to enhance sharpness (rather, configured to perform blur correction), the printing device 102 performs blur correction. Blur correction can be realized by using known techniques such as averaging filters and Gaussian filters. After the blur correction, the output is converted to RGB by the aforementioned processing in S308.

The sharpness function is realized by the flow described above. Note that, in the present embodiment, the degree of isolation is calculated using the standard deviation devY of the luminance Y around the pixel of interest, but the calculation is not necessarily limited thereto. Any feature amount may be used as long as it is a feature amount related to the dispersion of the luminance Y of the surrounding pixels around the pixel of interest. For example, the feature amount may be the dispersion value of the surrounding pixels or the difference between the pixel of interest and the average value of the surrounding pixels, or the magnitude of the average value may also be used as a reference value for determining whether the pixel of interest is isolated from the surroundings. Additionally, although color conversion from RGB to YCbCr has been described, this is not the only possible type of color conversion. In the case where data input to the printing device 102 is in the CMYK color space, converting the data to the luminance-chrominance Lab color space allows for the implementation identical to the flow described above. Furthermore, by switching the filter coefficients used in S304 to filter coefficients with higher gain as mentioned below, sharpness can be further enhanced. Hereinafter, the following filter coefficients are referred to as the coefficients for sharpness “+2”.
−0.20, −0.40, −0.60, −0.40, −0.20
−0.40, +0.20, +0.80, +0.20, −0.40
−0.60, +0.80, +2.40, +0.80, −0.60
−0.40, +0.20, +0.80, +0.20, −0.40
−0.20, −0.40, −0.60, −0.40, −0.20

### <Effects of Sharpness Function>

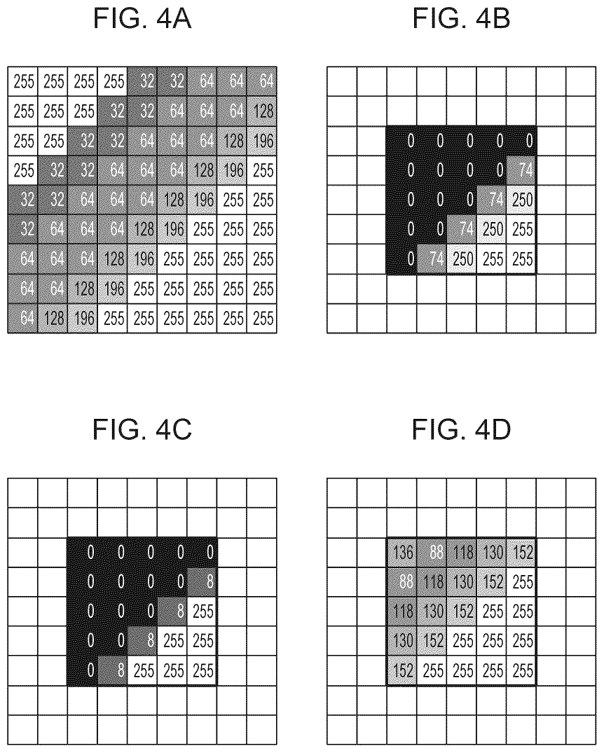

Next, the effects of the sharpness function will be described using FIGS. 4A to 4D. FIG. 4A illustrates a diagonal line serving as the original image. FIG. 4B illustrates an image in the case where each pixel of the 5×5 pixels at the center of FIG. 4A is processed with the coefficients for sharpness “+1”. FIG. 4C illustrates an image in the case where each pixel of the 5×5 pixels at the center of FIG. 4A is processed with the coefficients for sharpness “+2”. FIG. 4D illustrates an image in the case where each pixel of the 5×5 pixels at the center of FIG. 4A is blurred. Note that the numerical values in these diagrams indicate the luminance component Y, and in FIGS. 4B and 4C, the processing results are clipped at the maximum value 255 and the minimum value 0. Additionally, blurring is the result of processing using the following 5×5 Gaussian filter coefficients. In the present embodiment, the commonly used 3×3 Gaussian coefficients are expanded to a filter size of 5×5 for application:
0.0000, 0.0000, 0.0000, 0.0000, 0.0000
0.0000, 0.062701250, 0.0625, 0.0000
0.0000, 0.1250, 0.2500, 0.1250, 0.0000
0.0000, 0.062701250, 0.0625, 0.0000
0.0000, 0.0000, 0.0000, 0.0000, 0.0000

In the original image illustrated in FIG. 4A, dark luminance values and bright luminance values are evenly distributed, resulting in blurred lines. Here, since sharpness processing has been performed in FIGS. 4B and 4C, the distribution of dark luminance values and bright luminance values is uneven, and the edges are enhanced. Also, since sharpness processing has been performed with the coefficients for sharpness “+2” in FIG. 4C, the distribution of luminance values is further uneven, and the edges are further enhanced as compared to FIG. 4B. In the meantime, since blurring has been performed in FIG. 4D, the brightness/darkness of the lines are less obvious as compared to FIG. 4A.

As described above, the user can choose the intended image quality by switching the sharpness setting.

However, as described above, since the sharpness function is a function unique to the printer vendor, it is not displayed on the detailed settings screen displayed by the general-purpose printing software 202. That is, in the case where the user uses IPP Class Driver, the user is unable to choose the sharpness function, meaning that it is not possible to perform printing using the sharpness function.

The description will now return to FIG. 2A. When a print instruction is issued from the rendering application 201, the OS module within the general-purpose printing software 202 generates intermediate data (also called input data). Note that the data output by the rendering application 201 for printing is data in Graphic Device Interface format (data in GDI format) or data in XML Paper Specification format (data in XPS format). It is assumed that IPP Class Driver is used as the general-purpose printing software 202. In that case, if the data output by the rendering application 201 is data in GDI format, the OS converts the data in GDI format output from the rendering application 201 into data in XPS format. Note that the intermediate data includes rendering data, which is information about the image to be formed on the paper surface, and PT configured by the user.

The general-purpose printing software 202 converts the obtained intermediate data into print data that can be interpreted by the printing device 102 and sends it to the printing device 102. Here, the print data in the present embodiment is Page Description Language (PDL) data in accordance with IPP. The PDL data in accordance with IPP is, for example, data in Portable Document Format (PDF) or PWG-Raster format. Note that the print data includes rendering data, which is information about the image to be formed on the paper surface, and print setting attribute information (attribute information specifying the print settings) generated based on PT configured by the user. The print setting attribute information includes attribute information indicating the functions (capabilities of the printing device) that can be specified in the printing device 102 and their setting values related to the attribute information.

The printing device 102 performs printing on the paper surface based on the print data sent from the general-purpose printing software 202. At this time, the printing device 102 forms the rendering data included in the print data on the paper surface in an operation according to the print setting attribute information included in the print data. The print setting attribute information includes attribute information and its setting values for specifying print quality (such as image quality priority, speed priority, etc.), duplex printing, and the like. For example, in the case where the print setting attribute information includes attribute information specifying duplex printing and its setting value indicating to activate it, the printing device 102 executes duplex printing.

### <Configuration of Software-Centric Printing System (Case Where Extension Application 204 Is Associated)>

Referring now to FIG. 2B, the configuration of the printing system in the case where the extension application 204 is associated will be described. Note that the configuration and processing not specifically mentioned below is equivalent to that of FIG. 2A.

The extension application 204 is software for extending the functionality of the general-purpose printing software 202 and is software not included in advance in the OS. Therefore, it is necessary for the user to operate the host computer 101 and download the extension application 204 from the server via the Internet and install it.

Alternatively, the printing device 102 may be installed automatically based on the connection of the printing device 102 to the host computer 101. Specifically, when the printing device 102 is connected to the host computer 101, the OS obtains device identification information from the printing device 102. The OS may download the extension application 204 corresponding to the obtained device identification information from the server via the Internet and install it. That is, the general-purpose printing software 202 and the extension application 204 are retained in the host computer 101 as separate files.

Although the general-purpose printing software 202 and the extension application 204 may be updated and upgraded, the update processes are also performed at different timings. That is, the timing at which the general-purpose printing software 202 is obtained by the host computer 101 is different from the timing at which the extension application 204 is obtained. Also, the trigger for obtaining the general-purpose printing software 202 by the host computer 101 is different from the trigger for obtaining the extension application 204. When the extension application 204 is installed, the OS associates the extension application 204 with the general-purpose printing software 202 and the printing device 102.

The extension application 204 described in the present embodiment includes a print settings screen extension unit 205, a print function extension unit 206, an intermediate data editing unit 207, and a notification unit 209. The extension application 204 also includes shared information 208, which is commonly accessible to each unit. The reality of the shared information 208 is a file stored on the external storage device 114 or information stored on the RAM 113. The extension application 204 utilizes an Application Program Interface (API) provided by the OS to write and read information to and from the shared information 208.

Note that the extension application 204 may terminate operations each time the processing of each unit is completed. In that case, the OS will activate the extension application 204 each time it receives a request to use each unit.

Furthermore, the extension application 204 may cancel the processing during the processing of each unit. If the processing is canceled, the job being processed in the print queue will be deleted by the OS.

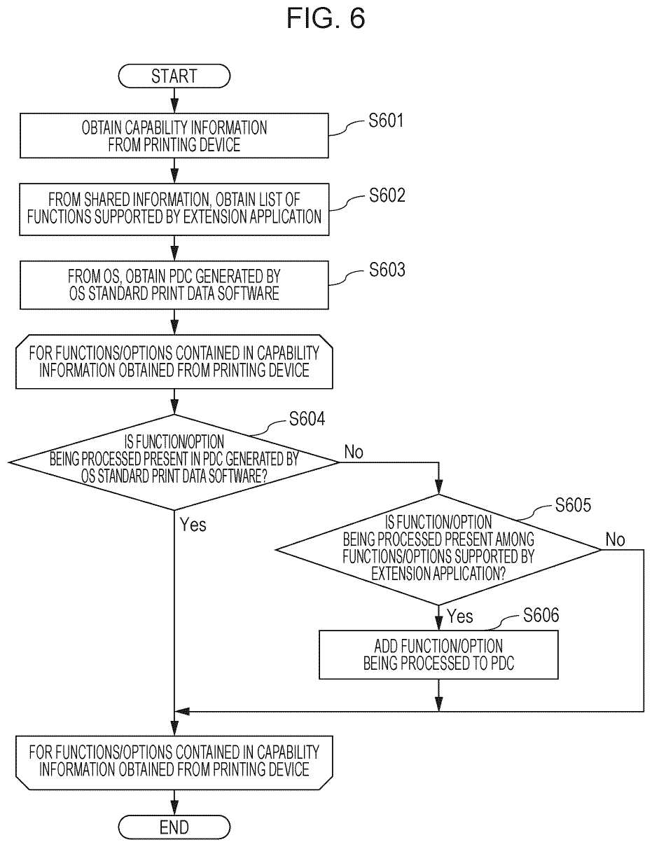

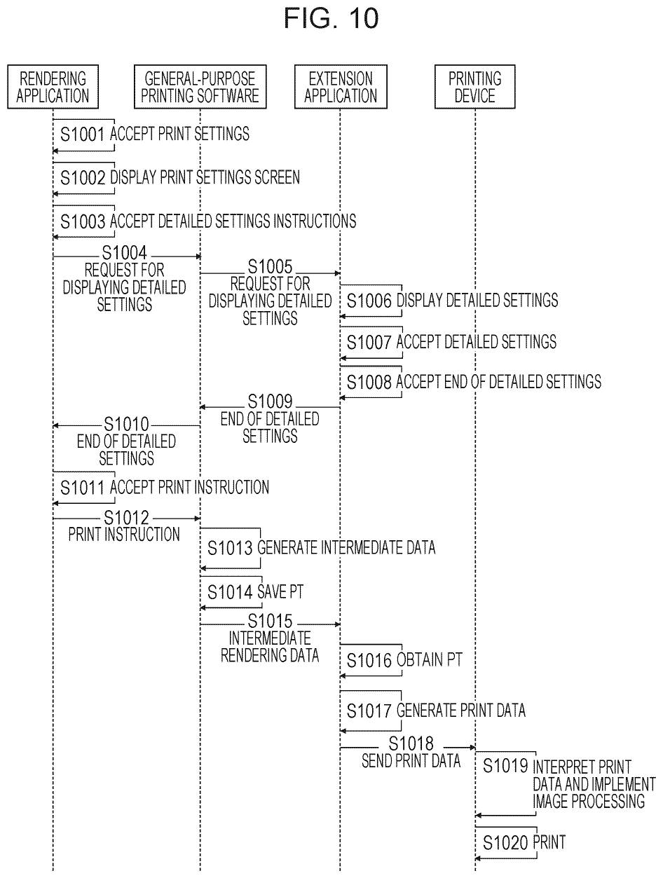

Upon receiving a print request from a user, the rendering application 201 issues a print instruction to the OS. With this configuration, as in the configuration illustrated in FIG. 2A, the rendering application 201 can display a print settings screen. With this configuration, a detailed settings screen provided by the extension application 204 is displayed. Specifically, a detailed settings screen provided by the print settings screen extension unit 205 included in the extension application 204 is displayed. The print settings screen extension unit 205 can also save the detailed settings configured by the user to the shared information 208. The print settings screen extension unit 205 will be described in detail later using FIGS. 6 and 10.

The extension application 204 has the intermediate data editing unit 207. The intermediate data editing unit 207 obtains intermediate data from the general-purpose printing software 202, converts it into print data, and then passes the print data to the printing device 102. Furthermore, the intermediate data editing unit 207 obtains the detailed settings information from the shared information 208 and adds the detailed settings to the print data.

The printing device 102 performs printing on the paper surface based on the received print data. Note that the method of converting intermediate data into print data is not limited to the above. The extension application 204 may be configured to obtain print data generated by the general-purpose printing software 202 and add detailed settings to the print data. Also, in the configuration illustrated in FIG. 2B, sharpness setting may not be configured by the user. In that case, as in the configuration illustrated in FIG. 2A, the general-purpose printing software 202 may pass the print data to the printing device 102 without going through the extension application 204.

The extension application 204 has the print function extension unit 206. The print function extension unit 206 is capable of editing the PDC 203 generated by the general-purpose printing software 202 or the OS. This allows the print function extension unit 206 to add functions provided by the extension application 204. In addition, the print function extension unit 206 can add a function (sharpness function) that is supported by the printing device 102 but not supported by the general-purpose printing software 202, add exclusive relationships between the setting values of the print functions, and the like. The OS activates the print function extension unit 206 when the extension application 204 is first associated with the printing device 102 and the general-purpose printing software 202. Furthermore, the OS may activate the print function extension unit 206 at other timings, such as when the OS is activated. In doing so, in cases where optional devices (e.g., finisher) are later added to the printing device 102 and functions related to printing are extended, the print function extension unit 206 can detect the extended functions and add them to the PDC 203.

The extension application 204 also has the notification unit 209. The notification unit 209 can display a notification to the user in response to the occurrence of an error in the printing device 102. For example, when a paper-out error occurs in the printing device 102, the general-purpose printing software 202 detects it, and in turn the OS uses its function called toast notification, which is a notification function, to display a message on the display unit 119. When the user presses this toast notification, the notification unit 209 of the extension application 204 is called by the OS, and the UI screen of the notification unit 209 is displayed. On the UI screen of the notification unit 209, for example, it is possible to display a detailed message about the paper-out error and instructions on how to refill the paper.

Once the extension application 204 sends the print data to the printing device 102, it is unable to display screens such as guides or other information tied to the print data during the processing of each unit.

Additionally, the configuration of the extension application 204 for realizing the present embodiment is not limited to that including all of the aforementioned functions (units), and the configuration may have only some of the functions or other functions. The extension application 204 may also be simply referred to as printing software. As described above, it can be said that the extension application 204 includes at least one of the following functions. The first is a function of displaying a settings screen (print settings screen extension unit 205). The second is a function of editing intermediate data, converting it into print data, and adding detailed settings to the print data (intermediate data editing unit 207). The third is a function of extending the functions that can be specified in print data generation software (print function extension unit 206). The fourth is a function of displaying a screen in response to the occurrence of an error in the printing device 102 (notification unit 209).

### Example of Print Settings Screen/Detailed Settings Screen

Next, an example of the print settings screen and the detailed settings screen in the present embodiment will be described using FIGS. 5A to 5C. FIG. 5A illustrates a print settings screen displayed by the rendering application 201. FIG. 5B illustrates a detailed settings screen displayed in the case of the configuration without the extension application 204 illustrated in FIG. 2A. FIG. 5C illustrates a detailed settings screen displayed in the case of the configuration with the extension application 204 illustrated in FIG. 2B. Note that the units and modules for displaying the print settings screen are not limited to the above. For example, the print settings screen extension unit 205 may be configured to only generate display screens. In that case, the print settings screen extension unit 205 sends the generated display screen to the rendering application 201 via the general-purpose printing software 202. The rendering application 201 may be configured to display the obtained display screen.

### <Print Settings Screen Displayed by Rendering Application 201 (FIG. 5A)>

First, FIG. 5A will be described. Control 501 has individual objects that allow the user to set the destination printer to which the image data is sent (the printer used for printing), the orientation of the printout, and the number of copies to be printed. Control 502 is a preview screen, control 503 is a print start button, and control 504 is a button to cancel printing. Control 505 is a detailed settings button, and, when control 505 is pressed, an additional print screen is displayed by the general-purpose printing software 202 or the print settings screen extension unit 205.

### <Detailed Settings Screen Displayed by General-Purpose Printing Software 202 (FIG. 5B)>

FIG. 5B will now be described. FIG. 5B illustrates a detailed settings screen displayed by the general-purpose printing software 202 in the absence of the extension application 204. Control 506 allows the user to set the type of paper, and it is illustrated that plain paper has been selected. Similarly, control 507 allows the user to specify the paper size, and control 508 allows the user to specify the paper feed slot. Control 509 is a finish settings button, and, when control 509 is pressed, the screen returns to the print settings screen illustrated in FIG. 5A.

### <Print Settings Screen Displayed by Print Settings Screen Extension Unit 205 (FIG. 5C)>

FIG. 5C will now be described. FIG. 5C illustrates an additional settings screen displayed by the print settings screen extension unit 205 in the presence of the extension application 204. Unlike FIG. 5B, control 510 and list 511 are added. Control 510 is a button that allows the user to select the sharpness setting, and it is indicated that the standard has been selected. When control 510 is pressed, list 511 displays the sharpness setting options. List 511 indicates that there are “−1”, “0”, and “+2” in addition to the currently selected “+1”. The sharpness setting “0” indicates that no sharpness processing will be performed. The sharpness settings “+1” and “+2” are settings that enhance sharpness, and “+2” is a setting that enhances sharpness more than “+1”. The sharpness setting “−1” is a setting that reduces the sharpness of the image. The user can switch the sharpness function and perform printing by selecting the sharpness setting from list 511 to achieve the desired image quality. Note that, in the present embodiment, if sharpness “−1” is selected, processing is performed using the previously mentioned 5×5 Gaussian filter. In addition, if sharpness “+1” is selected, the coefficients for sharpness “+1” as previously described are used in the sharpness processing; and, if sharpness “+2” is selected, the coefficients for sharpness “+2” as previously described are used in the sharpness processing. In this way, the user can configure whether to execute the sharpness processing as well as the level (intensity) of the sharpness processing. However, the present disclosure is not limited to the above; it may also be configured to only accept a setting on whether to execute the sharpness processing.

Now, the reason the print setting options differ between FIGS. 5B and 5C will be described. A detailed settings screen is generated with reference to PC generated based on print function information. However, since the general-purpose printing software 202 does not support the sharpness function, the sharpness function cannot be added to the print function information. Furthermore, even if the sharpness function is originally contained in the print function information, the general-purpose printing software 202 is unable to interpret the sharpness function contained in the print function information; consequently, it cannot display the sharpness setting on the detailed settings screen. However, the print function extension unit 206 is configured to add the sharpness function to the PDC 203, and the print settings screen extension unit 205 is configured to refer to PC to display the detailed settings screen. With these configurations, the extension application 204 is capable of displaying the sharpness setting on the detailed settings screen. Note that FIG. 5C may include additional extended functions other than the sharpness function.

### <Flowchart of Print Function Extension Unit 206 Editing PDC 203>

Here, using FIG. 6, the processing flow of the print function extension unit 206 editing the PDC 203 will be described. Note that each step is realized by the CPU 111, which reads each unit from the external storage device 114 into the RAM 113 and executes it.

First, in S601, the print function extension unit 206 obtains capability information from the printing device 102. The capability information includes attribute information indicating functions that can be specified in the printing device 102 and their setting values related to the attribute information, which are included in a response obtained by issuing an IPP Get-Printer-Attributes operation to the printing device 102.

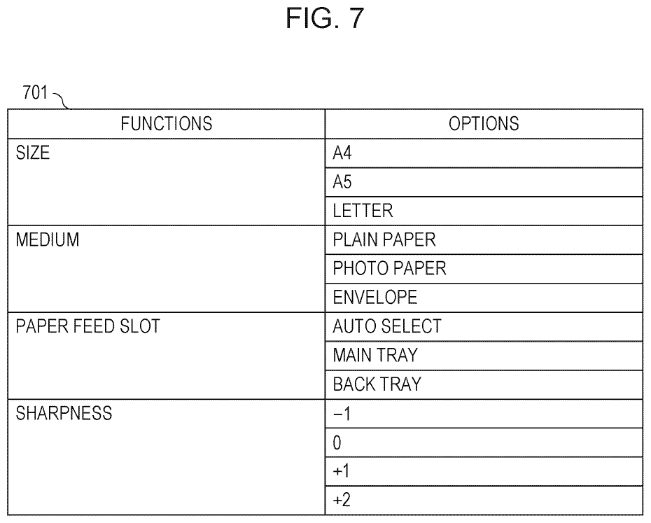

Table 701 illustrated in FIG. 7 depicts an example of a list of items of capability information obtained from the printing device 102 in table format. As illustrated in Table 701, functions such as sharpness and options configurable for each function can be obtained from the printing device 102.

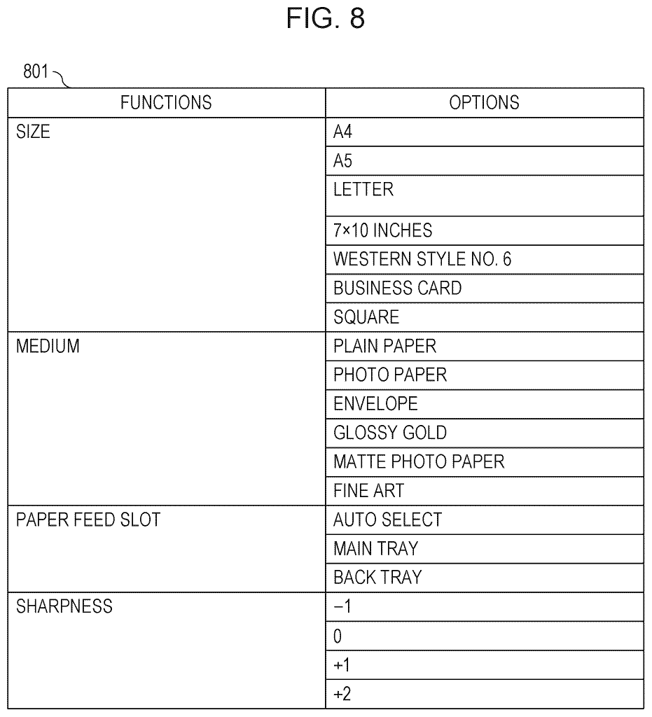

Next, in S602, the print function extension unit 206 obtains a list of print functions supported by the extension application 204 from within the shared information 208. The list of print functions supported by the extension application 204 is stored in the shared information 208, and includes all the print functions that can be processed by the extension application 204 as well as their respective setting values. Table 801 illustrated in FIG. 8 depicts an example of a list of print functions supported by the extension application 204. The list of print functions supported by the extension application 204 may also be updated, such as by an update of the extension application 204.

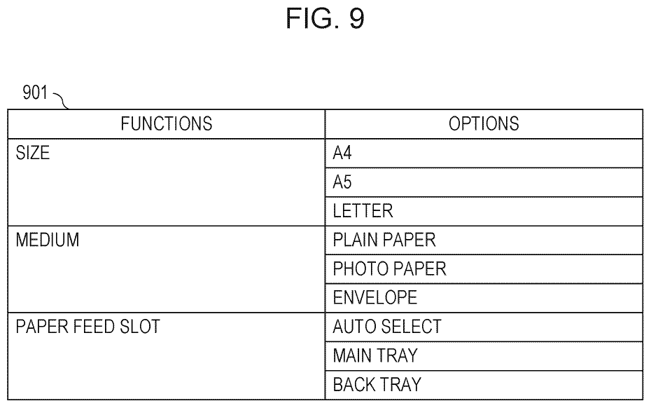

Then, in S603, the print function extension unit 206 obtains the PDC 203 generated by the general-purpose printing software 202 from the OS. Table 901 illustrated in FIG. 9 depicts an example of a list of print functions supported by the general-purpose printing software 202. The PDC 203 generated by the general-purpose printing software 202 is generated based on capability information 701 obtained by the general-purpose printing software 202 from the printing device 102. The PDC generated by the general-purpose printing software 202 contains only the print functions supported by the general-purpose printing software 202, out of the capability information obtained from the printing device 102, and thus the functionality of the PDC is limited. For example, the capability information 701 obtained from the printing device 102 includes the sharpness function, but the general-purpose printing software 202 does not support the sharpness function, and the sharpness function is not described in the PDC. When the print function extension unit 206 adds functions and options to the PDC, the extension application 204 can compensate for the lack of functionality of the general-purpose printing software 202. The print function extension unit 206 can also delete unwanted functions and options from the PDC generated by the general-purpose printing software 202.

The processing thereafter in S604, S605, and S606 is processing repeatedly performed for the list of functions contained in the capability information obtained from the printing device 102 in S601. In the present embodiment, the processing is repeated for thirteen types included in table 701, ranging from the size A4 up to the sharpness +2.

First, in S604, the print function extension unit 206 determines whether the function/option being processed is present in the PDC generated by the general-purpose printing software 202. If it is determined to be YES, the next item in the functions/options contained in the capability information obtained from the printing device 102 is selected, and S604 is performed again. In the case where the last item in the functions/options contained in the capability information obtained from the printing device 102 is being processed, the flowchart illustrated in FIG. 6 ends. If it is determined to be NO, the flow proceeds to S605. In the present embodiment, for example, because the size A4 indicated in table 701, which is the capability information of the printing device 102, is also present in table 901, which is the capability information of the general-purpose printing software 202, it is determined to be YES. In contrast, because the sharpness +1 indicated in table 701 is not present in table 901, it is determined to be NO, and the flow proceeds to S605.

First, in S605, the print function extension unit 206 determines whether the function/option being processed is present in the functions/options supported by the extension application 204. If it is determined to be YES, the flow proceeds to S606. If it is determined to be NO, S604 is performed again as is the case if it is determined to be YES in S604, or the flowchart illustrated in FIG. 6 ends. In the present embodiment, for example, if the function being processed is the sharpness +1, it is also present in table 801, which is the capability information of the extension application 204; thus, it is determined to be YES, and the process proceeds to S606.

Next, in S606, the print function extension unit 206 adds the function/option being processed to the PDC 203. After the processing of S606, S604 is performed again as is the case if it is determined to be YES in S604, or the flowchart illustrated in FIG. 6 ends.

As described above, the print function extension unit 206 adds to the PDC 203 functions/options that are not supported by the general-purpose printing software 202 but are supported by the printing device 102 and the extension application 204. Based on the PDC edited by this processing, PC is generated. Furthermore, the print settings screen extension unit 205 generates a display screen based on the generated PC, thus extending functions not supported by the general-purpose printing software 202, which in turn makes it possible to display the detailed settings screen illustrated in FIG. 5C.

<Sequence after Rendering Application 201 Accepts Print Settings>

Next, using FIG. 10, a sequence of the rendering application 201, the general-purpose printing software 202, the extension application 204, and the printing device 102 after the rendering application 201 accepts print settings will be described. Note that each step other than those of the printing device 102 in FIG. 10 is executed by the CPU 111, which reads the rendering application 201, the general-purpose printing software 202, and the extension application 204 from the external storage device 114 into the RAM 113 and executes them. Each step performed by the printing device 102 in FIG. 10 is executed by the CPU 191 of the printing device 102, which reads a program stored in the ROM 192 or the external storage device 199 into the RAM 193 and executes it.

First, in S1001, the rendering application 201 accepts print settings from the user. The user may operate the pointing device 117 or the keyboard 118 to instruct the rendering application 201 on the print settings.

Next, in S1002, the rendering application 201 displays the print settings screen illustrated in FIG. 5A on the display unit 119.

Then, in S1003, the rendering application 201 accepts instructions on detailed settings.

The user may operate the pointing device 117 or the keyboard 118 to select control 505, thereby giving instructions on detailed settings.

Next, in S1004, the rendering application 201 issues a request for displaying the detailed settings to the general-purpose printing software 202.

Then, in S1005, the general-purpose printing software 202 issues a request for displaying the detailed settings to the extension application 204. As mentioned earlier, in the case of the configuration illustrated in FIG. 2A, the general-purpose printing software 202 will display the detailed settings screen illustrated in FIG. 5C.

Next, in S1006, the print settings screen extension unit 205 of the extension application 204 displays the detailed settings screen illustrated in FIG. 5C on the display unit 119. This is because, as described with reference to FIG. 6, the sharpness setting has been added to the PDC by the print function extension unit 206. The print settings screen extension unit 205 refers to the PC generated based on the PDC with the addition to cause the detailed settings screen illustrated in FIG. 5C to be displayed on the display unit 119.

Then, in S1007, the print settings screen extension unit 205 accepts the detailed settings.

In the present embodiment, as illustrated in FIG. 5C, it is assumed that the user has selected the following settings: paper type as plain paper, paper size as A4, paper feed slot as automatic, and sharpness as +1. The accepted settings are stored in the RAM 113 by the CPU 111.

Next, in S1008, the print settings screen extension unit 205 accepts that the detailed settings have been completed and instructs to write the accepted settings into the PT. The user may operate the pointing device 117 or the keyboard 118 to select control 509, thereby giving an instruction to end the detailed settings.

Then, in S1009, the extension application 204 sends to the general-purpose printing software 202 that the detailed settings have been completed.

Next, in 51010, the general-purpose printing software 202 sends to the rendering application 201 that the detailed settings have been completed.

Then, in S1011, the rendering application 201 accepts a print instruction.

The user may operate the pointing device 117 or the keyboard 118 to select control 503, thereby giving an instruction to print.

Next, in S1012, the rendering application 201 gives a print instruction.

Then, in S1013, the general-purpose printing software 202 generates intermediate data using the OS module.

Next, in S1014, the general-purpose printing software 202 saves the PT to the shared information 208. The general-purpose printing software 202 converts the contents of the PT into the setting values of IPP data and generates IPP data.

Then, in S1015, the general-purpose printing software 202 passes the intermediate data and the converted IPP data to the extension application 204.

Next, in S1016, the intermediate data editing unit 207 of the extension application 204 obtains the PT saved in S1014 from the shared information 208.

Then, in S1017, the intermediate data editing unit 207 of the extension application 204 adds the sharpness item name and its setting value to the extension area of the IPP data. The intermediate data editing unit 207 of the extension application 204 generates print data from the intermediate data.

Next, in S1018, the intermediate data editing unit 207 of the extension application 204 sends the print data to the printing device 102.

Then, in S1019, the printing device 102 interprets the print data and applies the necessary image processing to the image of the print data. In the present embodiment, in the case where the print settings illustrated in FIG. 5C have been configured, image processing at the sharpness +1 is performed. That is, image data with enhanced sharpness is generated compared to the case where sharpness processing is not performed. Here, in the present embodiment, as described with reference to FIGS. 4A to 4D, if the image data illustrated in FIG. 4A were the input data, an edge-enhanced image like the one illustrated in FIG. 4B would be generated.

Next, in S1020, the printing device 102 prints the image data generated in S1019. Since the processing at the sharpness +1 has been performed in S1019, the sharpness of the print sample is enhanced compared to the case where the sharpness processing is not performed.

As described above, in the present embodiment, the print settings screen extension unit 205 of the extension application 204 modifies the PDC 203 based on the capability information of the general-purpose printing software 202, the extension application 204, and the printing device 102. Furthermore, in response to a request from the user for a detailed settings screen, the setting screen is displayed based on the PC generated from the PDC 203, which allows the user to configure the sharpness setting. Yet furthermore, because the intermediate data editing unit 207 generates print data based on the configured sharpness setting, it can reflect the sharpness setting in the print data. Afterward, when the intermediate data editing unit 207 of the printing device 102 receives the print data with the sharpness setting reflected, the sharpness module within the printing device 102 applies the sharpness processing to the image data based on the sharpness setting. Through the series of processes described above, it is possible to realize the sharpness function in the printing device 102, which makes it possible to provide the sharpness function to the user.

Although the detailed settings screen illustrated in FIG. 5C is described with the configuration illustrated in FIG. 2B in the present embodiment, the present disclosure is not limited thereto. For example, if the general-purpose printing software 202 is requested to display the detailed settings in S1004, the general-purpose printing software 202 may display the detailed settings screen illustrated in FIG. 5B. Then, after completing the detailed settings illustrated in FIG. 5B, the general-purpose printing software 202 requests the extension application 204 to display an additional detailed settings screen. Next, the extension application 204 may additionally display a detailed settings screen where the sharpness setting can be configured.

In the present embodiment, an example in which the extension application 204 generates print data based on intermediate data generated by the general-purpose printing software 202 has been described. However, the extension application 204 may generate intermediate data by itself.

### Second Embodiment

Hereinafter, a second embodiment of the present disclosure will be described. In the first embodiment described above, the extension application 204 first generates print data, including the sharpness setting, and sends it to the printing device 102. The printing device 102 then interprets the print data, including the sharpness setting, and performs sharpness processing using the sharpness module within the printing device 102.

However, some printing devices may not be equipped with a sharpness module, taking cost and other factors into consideration. In that case, even if the extension application generates print data including the sharpness setting, the printing device cannot perform sharpness processing.

Therefore, if the printing device is not equipped with a sharpness module, it is preferable to generate print data using an image that has undergone sharpness processing and then pass it to the printing device.

Accordingly, in the second embodiment, whether the printing device is equipped with a sharpness module is first determined based on the capability information of the printing device. Next, if the printing device is equipped with a sharpness module, print data with the sharpness setting reflected is generated and passed to the printing device. In contrast, if the printing device is not equipped with a sharpness module, the extension application performs sharpness processing on the image of the rendering data. Then, the image that has undergone the sharpness processing is used to generate print data, which is then passed to the printing device. This makes it possible to provide the sharpness function to the user even in the case where the printing device is not equipped with a sharpness module.

Note that only the differences from the first embodiment will be described below. The differences between the second embodiment and the first embodiment reside in the following three points: the configuration of the printing system in the case where the extension application is associated, the PDC editing flow, and the sequence after the rendering application accepts the print settings.

### Configuration of Software-Centric Printing System in Second Embodiment (Case where Extension Application 1102 is Associated)

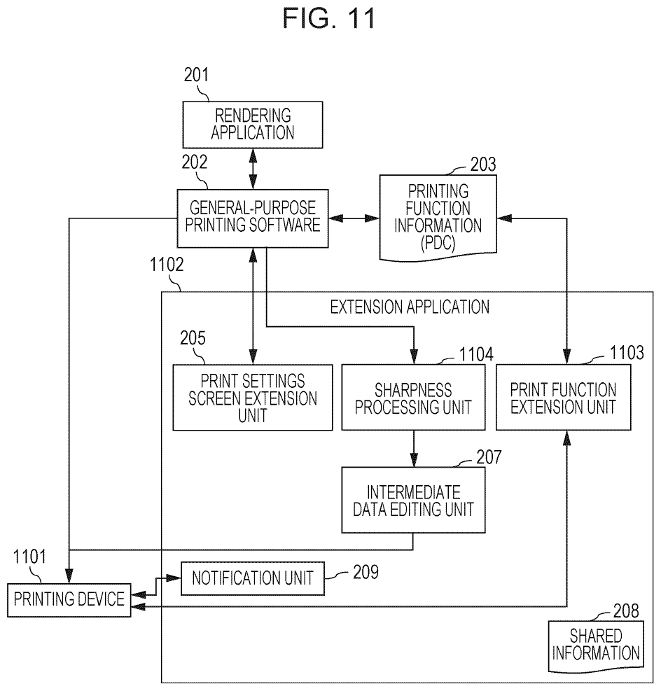

The configuration of the printing system in the case where an extension application 1102 is associated will be described using FIG. 11. In FIG. 11, blocks with the same reference numerals as in FIG. 2 are the same as in the first embodiment, and therefore their description is omitted. In FIG. 11, blocks different from FIG. 2 are the following four: a printing device 1101, the extension application 1102, a print function extension unit 1103, and a sharpness processing unit 1104. The printing device 1101 in the second embodiment is a printing device not equipped with a sharpness module, unlike the printing device 102 in the first embodiment. The extension application 1102 is configured differently from the extension application 204 in the first embodiment. Unlike the first embodiment, even if there is no sharpness function in the capability information obtained from the printing device, the print function extension unit 1103 adds a sharpness function to the PDC 203 if there is a unit within the extension application 204 that performs sharpness processing. The sharpness processing unit 1104 performs sharpness processing on the intermediate data (rendering data) received from the general-purpose printing software 202 based on the sharpness setting configured by the user. Details will be described later.

### Flowchart of Print Function Extension Unit 1103 Editing PDC 203 in Second Embodiment

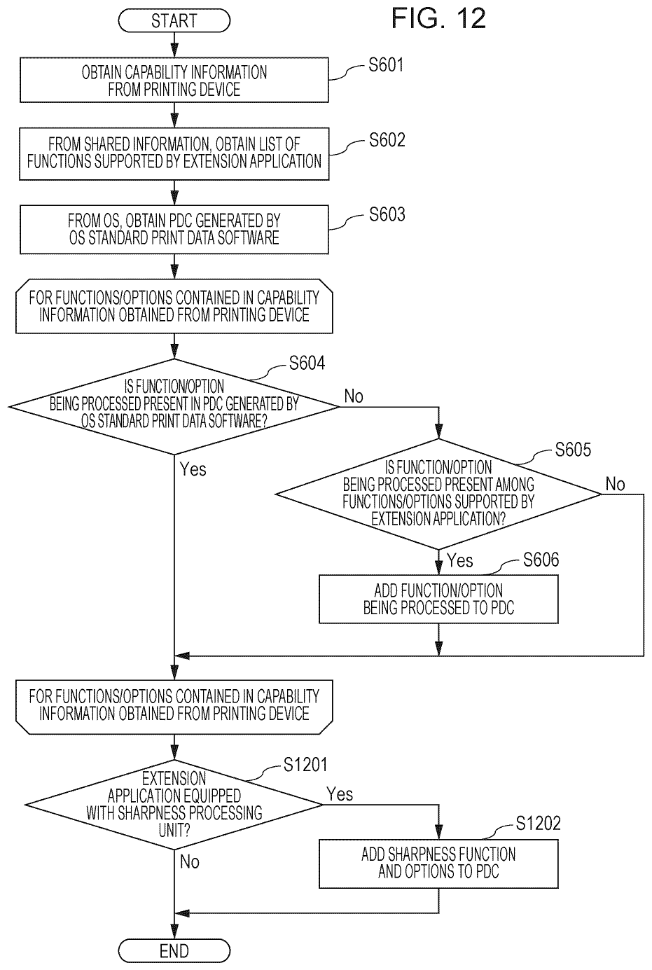

Using FIG. 12, PDC editing processing performed by the print function extension unit 1103 in the second embodiment will be described. Note that each step in FIG. 12 is realized by the CPU 111, which reads each unit from the external storage device 114 into the RAM 113 and executes it. Also, steps in FIG. 12 that have the same reference numerals as in FIG. 6 are the same as in FIG. 6, and therefore their description is omitted.

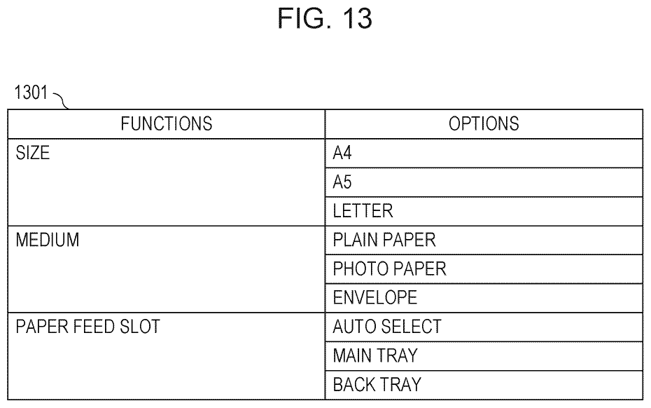

Upon completion of the repeated processing in S604 to S606, the print function extension unit 1103 proceeds to S1201. Here, in the second embodiment, the capability information returned from the printing device 1101 is depicted in table 1301 illustrated in FIG. 13. Unlike Table 701, the printing device 1101 in the second embodiment is not equipped with a sharpness module. Therefore, the sharpness function is not added to the PDC 203 after completion of the processing in S604 to S606.

Therefore, in S1201, a process is performed to add, to the PCD, one or more modules that are not included in the capability information returned from the printing device 1101 but are possessed by the extension application 1102.

Specifically, in S1201, the print function extension unit 1103 refers to table 1301 illustrated in FIG. 13 and the PDC 203 to determine whether there is a module in the extension application 204 that performs sharpness processing. If it is determined to be YES, the process proceeds to S1202, and if it is determined to be NO, the process of FIG. 12 ends. Because the extension application 204 in the second embodiment is equipped with the sharpness processing unit 1104, the flow proceeds to S1202.

Next, in S1202, the print function extension unit 1103 adds the sharpness −1, 0, +1, and +2 in table 801 to the PDC. As described above, the print function extension unit 1103 first adds to the PDC 203 functions/options that are not supported by the general-purpose printing software 202 but are supported by the printing device 102 and the extension application 204. Afterward, it is determined whether the extension application 204 is equipped with a sharpness processing unit, and, in the case where the extension application 204 is equipped with a sharpness processing unit, a sharpness function is added to the PDC. With this process, even in the case where the printing device 1101 is not equipped with a sharpness module, the print settings screen extension unit 205 generates a display screen based on PC generated based on PDC, allowing the detailed settings screen illustrated in FIG. 5C to be displayed.

### Sequence after Rendering Application 201 Accepts Print Settings in Second Embodiment

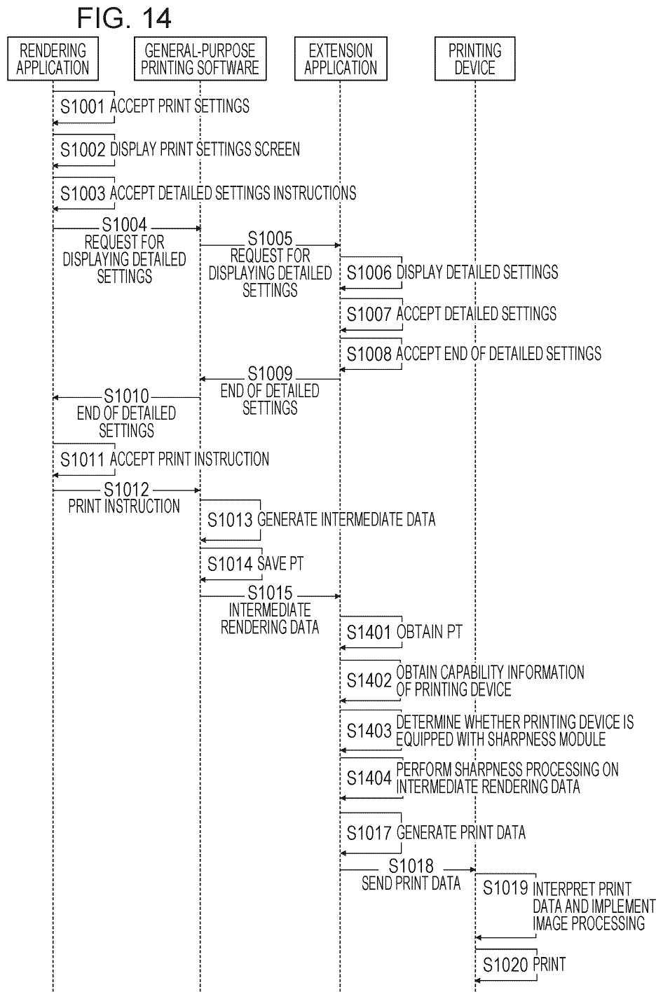

Next, using FIG. 14, a sequence of the rendering application 201, the general-purpose printing software 202, the extension application 1102, and the printing device 1101 after the rendering application 201 accepts print settings will be described. Note that each step other than those of the printing device 1101 in FIG. 14 is executed by the CPU 111, which reads the rendering application 201, the general-purpose printing software 202, and the extension application 1102 from the external storage device 114 into the RAM 113 and executes them. Each step performed by the printing device 1101 in FIG. 14 is executed by the CPU 191 of the printing device 1101, which reads a program stored in the ROM 192 or the external storage device 199 into the RAM 193 and executes it. Also, steps in FIG. 14 that have the same reference numerals as in FIG. 10 are the same as in FIG. 10, and therefore their description is omitted.

In S1401, the sharpness processing unit 1104 of the extension application 1102 obtains PT and obtains the sharpness setting. Note that, if sharpness is set to 0, sharpness processing is not performed, and thus subsequent steps S1402 to S1404 are skipped.

Next, in S1402, the sharpness processing unit 1104 of the extension application 1102 obtains capability information of the printing device 1101 from the shared information 208. If there is no capability information for the printing device 1101, the print function extension unit 1103 may request the capability information from the printing device 1101 and save it to the shared information 208.

Next, in S1403, the sharpness processing unit 1104 of the extension application 1102 determines whether the printing device 1101 is equipped with a sharpness module based on the capability information obtained in S1402. It is determined to be NO since the printing device 1101 is not equipped with a sharpness module in the second embodiment. If it is determined to be YES, subsequent step S1404 is skipped, and print data is generated. This is basically because the sharpness module in the printing device 1101 is able to perform sharpness processing faster than the sharpness processing unit 1104. Specifically, the sharpness module in the printing device 1101 is configured to be capable of performing processing at high speed with the use of an application specific integrated circuit (ASIC).

Next, in S1404, the sharpness processing unit 1104 of the extension application 1102 performs sharpness processing on the intermediate rendering data based on the sharpness setting obtained in S1401 and saves the processed data to the shared information 208. Also, the sharpness setting in PT is edited to “0”. Alternatively, the sharpness setting is deleted from the PT.

As described above, even in the case where the printing device is not equipped with a sharpness module in the second embodiment, it is possible to provide a sharpness function to the user.

### Other Embodiments

In the first embodiment, an example has been described in which the intermediate data editing unit 207 generates print data with the sharpness setting reflected and sends it to the printing device 102, which makes it possible to provide a sharpness function to the user. In the second embodiment, the sharpness processing unit 1104 first determines whether the printing device 1101 is equipped with a sharpness module. Then, if it is determined that the printing device 1101 is not equipped with a sharpness module, the sharpness processing unit 1104 performs sharpness processing on the intermediate data. In contrast, if the printing device 1101 is equipped with a sharpness module, the sharpness processing unit 1104 does not perform sharpness processing. Instead, the intermediate data editing unit 207 generates print data with the sharpness setting reflected and sends it to the printing device 102. As described above, even in the case where the printing device is not equipped with a sharpness module in the second embodiment, it is possible to provide a sharpness function to the user. However, the present disclosure is not limited to the above. For example, in the case where it is determined that the printing device 1101 is not equipped with a sharpness module, it is acceptable to display the screen illustrated in FIG. 5B in response to selection of detailed settings control 505 illustrated in FIG. 5A.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-106708, filed Jun. 29, 2023, which is hereby incorporated by reference herein in its entirety.

What is claimed is:

1. A non-transitory computer-readable storage medium storing a program that extends functionality of general-purpose printing software commonly usable by image forming devices provided by a plurality of manufacturers, the program, which when executed by one or more processors of a computer, cause the computer to perform operations comprising:
displaying, on a display unit, a display screen that accepts a setting for sharpness processing; and
based on the setting accepted on the display screen, for image data generated by the general-purpose printing software, setting that the sharpness processing be executed by an image forming device to which the image data is sent.

2. The non-transitory computer-readable storage medium according to claim 1, wherein the setting for the sharpness processing is a setting for whether to execute the sharpness processing.

3. The non-transitory computer-readable storage medium according to claim 1, wherein:
the setting for the sharpness processing includes a setting for an intensity of the sharpness processing, and
for image data generated by the general-purpose printing software, it is set that the sharpness processing be executed by the image forming device based on the intensity set on the setting screen.

4. The non-transitory computer-readable storage medium according to claim 3, the operations further comprising:
displaying a plurality of intensities of sharpness on the display screen; and
accepting, from a user, one intensity of sharpness from among the plurality of intensities of sharpness.

5. The non-transitory computer-readable storage medium according to claim 1, the operations further comprising:
executing the sharpness processing on the image data.

6. The non-transitory computer-readable storage medium according to claim 5, the operations further comprising:
determining whether the image forming device is capable of executing the sharpness processing;
in a case where it is determined that the image forming device is capable of executing the sharpness processing, based on the sharpness setting set on the display screen, for image data generated by the general-purpose printing software, setting that the sharpness processing be executed by the image forming device; and
in a case where it is determined that the image forming device is incapable of executing the sharpness processing, based on the sharpness setting set on the display screen, executing the sharpness processing on intermediate data generated by the general-purpose printing software.

7. A non-transitory computer-readable storage medium storing a program that extends functionality of general-purpose printing software commonly usable by image forming devices provided by a plurality of manufacturers, the program, which when executed by one or more processors of a computer, cause the computer to perform operations comprising:
displaying, on a display unit, a display screen that accepts a setting for sharpness processing; and
based on the setting accepted on the display screen, performing the sharpness processing on image data generated by the general-purpose printing software.

8. The non-transitory computer-readable storage medium according to claim 7, wherein:
the setting for the sharpness processing includes a setting for an intensity of the sharpness processing; and
for image data generated by the general-purpose printing software, it is set that the sharpness processing be executed by an image forming device to which the image data is sent, based on the intensity set on the display screen.

9. The non-transitory computer-readable storage medium according to claim 8, the operations further comprising:
displaying a plurality of intensities of sharpness on the display screen,
the program further including code that accepts, from a user, one intensity of sharpness from among the plurality of intensities of sharpness.

10. An information processing method for extending functionality of general-purpose printing software commonly usable by image forming devices provided by a plurality of manufacturers, the information processing method comprising:
displaying, on a display unit, a display screen that accepts a setting for sharpness processing; and
based on the setting accepted on the display screen, for image data generated by the general-purpose printing software, setting that the sharpness processing be executed by an image forming device to which the image data is sent.

11. An information processing apparatus having a program that extends functionality of general-purpose printing software commonly usable by image forming devices provided by a plurality of manufacturers, the information processing apparatus comprising:
a display unit configured to display, through execution of the program, a display screen that accepts a setting for sharpness processing; and
a setting unit configured to, based on the setting accepted on the display screen, for image data generated by the general-purpose printing software, set, through execution of the program, that the sharpness processing be executed by an image forming device to which the image data is sent.
